(19) United States
(12) Patent Application Publication
(10) Pub. No.: US 2008/0029024 A1
(43) Pub. Date: Feb. 7, 2008

(54) APPLICATOR

(76) Inventors: Hirofumi Morita, Tokyo (JP); Takeo Nakazawa, Nerima-ku (JP); Junichi Itoh, Chiba (JP)

Correspondence Address: Todd T. Taylor;Taylor & Aust, P.C., 142 S. Mian Street, P.O. Box 560, Avilla, IN, 46710, US

(21) Appl. No.: 11/849,634

(22) Filed: Sep. 4, 2007

Related U.S. Application Data
(63) Continuation of application No. PCT/EP06/50424, filed on Jan. 25, 2006.

(30) Foreign Application Priority Data
Mar. 14, 2005 (JP) 2005-71218

(51) Int. Cl. B05C 5/00; B05C 3/02; B05C 3/12

(52) U.S. Cl. 118/412; 118/420

(57) ABSTRACT

This invention relates to an applicator for applying coating medium, in particular coating medium in several layers onto a running web surface. The applicator includes several curtain heads, which are arranged at random distances apart and from which the coating media or colors are dispensed downward, and an inclined guide face which—as the result of lamination of the coating media or colors dispensed one after the other from each of the several curtain heads along the incline in order to form the several medium or color layers and, in addition, to form a color curtain from a curtain guide part pointing downwards—moves the color layers at the end of the part of the incline onto the web surface.

### CROSS REFERENCE TO RELATED APPLICATIONS

This is a continuation of PCT application No. PCT/EP2006/050424, entitled “APPLICATION DEVICE”, filed Jan. 25, 2006, which is incorporated herein by reference.

### BACKGROUND OF THE INVENTION

1. Field of the Invention

This invention relates to an applicator for applying coating medium, for example color, in several layers onto a running web.

2. Description of the Related Art

Up to now it was necessary, during the production of coated paper for use as general printing paper, for example for catalogs etc., pressure-sensitive paper, heat-sensitive paper and card paper for automatic card dispensing machines, to carry out dosing operations by way of a standard post-dosing applicator (a doctor coating unit etc.) after applying color onto a web surface acting as base paper. Machines which are used for such applications of color are commonly known as applicators.

Up to now the most common of these applicators, namely doctor coating units, bar applicators and air doctor applicators, have used a post-dosing method with which a dosing operation is carried out after color is applied onto a web surface.

In the past few years, the color application step using a post-dosing applicator has been widely replaced by curtain applicators (pre-dosing applicators) on which, as is shown in the schematic cross-section of the main part of FIG. 11, colors ta, tb are applied onto the surface of a web w by dispensing the colors ta, tb from the upper curtain heads 101a, 101b onto the web w running in the direction of the arrow in order to form color curtains ca, cb.

Also available is a multilayer application method known as an application method with displaceable nozzle.

Attention is drawn in this case to the Japanese Patent Specification No. 63-239.

When using the above described curtain applicators for photographic films or the like with a low running speed (120 m/min, 2 to 3 m/sec), the color ta is normally applied as a first layer onto the film surface and the color tb as a second layer onto the color ta which was applied onto the film surface because there is only a small difference between the falling speed of the colors ta, tb and the running speed of the film.

However, when this type of curtain applicator is used on a paper web w, the running speed of the web is high, namely 300 to 1800 m/min (5 to 60 m/sec) and the falling speed of the colors ta, tb equals 3 m/sec, which means that the difference in speed between the two speeds is greater by a magnitude of 20.

In this case the color ta applied as first layer onto the web w can be drawn evenly over the surface of the web w and be applied normally without creating any coating irregularities such as spot formation. However, as described above, there is often a large difference in speed in the case of the color tb, which is to be applied onto the color ta which has already been applied onto the surface of the web w; furthermore, depending on the color type, great differences in surface condition, including the coefficient of friction, arise between the surface of the web w, onto which the color ta is applied, and the color ta, which has been applied onto the surface of the web w and onto which the color tb is to be applied.

If slip occurs between the color tb and the color ta, which has already been applied onto the surface of the web w, then the color tb cannot easily be drawn over the color ta and an irregularity such as spot formation arises in the coating.

To prevent this problem, a single thick film color curtain formed by the close arrangement of two color curtains ca, cb dispensed from the curtain heads 101a, 101b is applied onto the surface of the web w and, by solving the problem of slip between the colors on the web w, an irregularity such as spot formation in the coating is prevented (see FIG. 3 of the cited publication 1).

A single color curtain is used because the single color curtain includes several color layers owing to the fact that the colors are mixed, and even if the overflowing color from the surface of the web w is recovered, it cannot be used again.

To eliminate color waste it is accordingly difficult to regulate the width of the color jet with regard to the width of the web w, which represents the article to be coated, and to guarantee this conformance if the width of the article to be coated is changed.

Because the curtain application method of the prior art generally requires the formation of independent color curtains, it can also happen, when performing coatings at low speed, that curtains are formed which are unstable and tear easily; consequently, no normal coating can be achieved.

Furthermore, when performing a continuous curtain application using several colors, the coated layers are easily impaired, on account of the thin film thickness of the colors used during the application process, not only by the layer coated underneath but also by the layer coated on top, thus leading to a roughing of the coated surface.

To prevent this, a flow rate of the magnitude which was used when forming the color curtain is required.

Furthermore, in the case of the application method with displaceable nozzle of the multilayer application method according to the description of the cited publication 1, the feeding of color to the unused heads must be stopped at the end of the application, and if the feeding of color to the unused heads is not stopped, this will lead to mixing of the colors when the device is operated, and the colors can no longer be recovered independently.

Although no mixing of the colors occurs during operation of the machine, when the feeding of color to the unused heads is stopped, then the colors will dry out in the unused nozzle head parts and stick to the heads because the colors cannot be circulated.

Hence during subsequent operations performed when color is stuck to the heads, this soiling of the heads leads to the formation of streak patterns, clogging of the nozzle slit and the non-uniform feeding of color in the width direction.

When the color to any one of the heads is stopped, then the application must be stopped accordingly and the heads cleaned, and because the cleaning water used for this cleaning operation rinses the other heads as well during operation, all other heads must be stopped and cleaned simultaneously when the color to any one of the heads is stopped.

Changing the type of product to be coated thus involves a great amount of time because the application process must also be stopped of course and all the heads must be cleaned.

As such, the multilayer application method with displaceable nozzle is problematic inasmuch as it results in a mixing of the colors, controlling the colors of each layer is difficult, all the heads have to be cleaned when a change of application is performed, and the process of starting and stopping the application is difficult.

What is needed in the art is a curtain applicator on which the development of coating faults such as spot formation is prevented during the formation of several color layers on a web surface, and on which in addition coatings can be produced according to the liquid properties of the colors, and the recovery of surplus color is guaranteed.

### SUMMARY OF THE INVENTION

The present invention provides an applicator for applying coating media, for example colors, in several coatings onto a running web. The applicator includes several curtain heads, which are arranged at random distances apart and from which the coating media or colors are dispensed downward, and a guide face, which moves the medium or color layers onto a web surface through lamination of the media or colors dispensed in succession from each of the several curtain heads onto an incline accompanying their run along the incline in order to form the several layers of medium or color and also to form a medium curtain from a curtain guide part on the end part of the incline.

In the following, the description of the invention will essentially use the term “color” and color curtain, color layers, etc. It is understood herein that a coating medium includes all colors and any other substance, such as starch for whitening, used in coating a web of fibrous material. On the other hand, it is expressly noted, however, that the use of the term “color” is to be regarded as standing for all coating media.

According to a second embodiment of the applicator, the color layers of the color layers moved along the incline and dispensed from a curtain head lying on the downstream side are wider than the color layers dispensed from an adjacent curtain head lying on the upstream side and cover in addition the two side edges of the color layers.

According to a third embodiment of the applicator, at least one of the curtain heads of the several curtain heads includes a jet guide part which is arranged near a color jet in order to guide the dispensed color onto the incline of the guide face.

According to a fourth embodiment of the applicator, the jet guide part is arranged in the top-most upstream curtain head.

According to a fifth embodiment of the applicator, the jet guide part includes a color guide part for guiding to the guide face incline the color dispensed from the curtain head, and a recovery guide part, which is arranged alongside and in a different direction to the color guide part, for deflecting the flow of surplus color.

According to a sixth embodiment of the applicator, the jet guide part includes a pair of wedge-shaped flow deflection guide members which grow larger toward the downstream side, wherein the distance between them has the same dimension as the width of the color used in the coating, wherein the color flowing between the pair of flow deflection guide members is used for coating the web surface and the color flowing along the outer side of the pair of flow deflection guide members is recovered.

According to a seventh embodiment of the applicator, the applicator includes a container for catching the color dispensed from the curtain heads of the several curtain heads which are not used for the coating, and a circulation device for recirculating to the curtain heads the color caught by the container.

According to an eight embodiment of the applicator, the applicator includes a feeding device for feeding water or the like to the curtain heads of the several curtain heads which are not used for the coating, a container for catching the color dispensed from the curtain heads of the several curtain heads which are not used for the coating, and a circulation device for recirculating to the curtain heads the color caught by the container.

It is also possible for the applicator to be constructed such that a curtain dispensed from one curtain head is bigger or wider than the web or smaller or narrower than the web. It is possible, for example, for all the dispensed curtains to have the same width. However, it is particularly advantageous for the curtain dispensed from a curtain head on the downstream side to be wider than the width of the web and for the curtain from the adjacent upstream curtain head to be narrower than the width of the web. The advantage of this is that no mixed flow of medium or color occurs in the edge region of the web. The second medium, namely the medium dispensed from the upstream curtain head, is carried along completely by the first medium (starting from the downstream curtain head).

It should also be noted that the web can be guided in ascending, horizontal or descending mode when passing the applicator. Accordingly, the slideway must also be arranged in its orientation to the web guide.

As the result of the current invention, as described above, it is possible, owing to the fact that coating media or colors dispensed one after the other from the several curtain heads are laminated in succession on a guide face incline in order to form several color layers, to produce an optimum coating which corresponds to the flow properties of the colors and is independent of their flow rate.

In addition it is possible, owing to the formation of several color layers through lamination in succession on a guide face incline, to achieve a coating with low flow rates and to make color savings.

According to the second embodiment of the applicator, owing to the fact that the color layer dispensed from a curtain head on the downstream side is wider than the color layer dispensed from an adjacent curtain head on the upstream side of the above mentioned curtain head and also covers the two side edges of the color layer, there is no heightening of the two side edges of the applied layer and a normal coating with a uniform flow can be implemented.

According to the third embodiment of the applicator, it is possible, owing to the fact that at least one of the curtain heads of the several curtain heads includes a jet guide part arranged near a color jet, by way of which the dispensed color is guided to the guide face incline, for a normal coating to be implemented independently of the flow properties of the colors.

According to the fourth embodiment of the applicator, it is possible, on account of the fact that the jet guide part is arranged on the top-most upstream curtain head, for the color flowing in contact with the incline of the guide face to be guided by the jet guide part such that said color flows uniformly over the guide face incline and coating faults are prevented.

According to the fifth embodiment of the applicator, owing to the fact that the color used for the coating can be guided to the color guide part and to the guide face incline and surplus color can be deflected in its flow and caught by a recovery guide part, an economical and effective use of the colors is achieved.

According to the sixth embodiment of the applicator, it is possible, owing to the fact that the color used for the coating flows between a pair of flow deflection guide members when it is guided to the guide face incline and the flow of surplus color along the outer side of the pair of flow deflection guide members can be recovered, for an economical and effective use of the colors to be achieved.

According to the seventh embodiment of the applicator, the curtain heads can be selectively actuated during application mode.

According to the eight embodiment of the applicator, the curtain heads and pipes etc. can be cleaned through the circulation of water and the like.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows a schematic cross section of the applicator related to the embodiment of the current invention;

FIG. 2a shows an enlarged view of the first curtain head of the applicator in FIG. 1;

FIG. 2b shows an enlarged view of the second, third and fourth curtain head of the applicator in FIG. 1;

FIG. 3a shows a schematic lateral cross section of the case in which no jet guide part is constructed in the applicator of the embodiment;

FIG. 3b shows a schematic lateral cross section of the case in which a color curtain formed by dispensing a second color from a second curtain head drops onto the color flowing along a guide face;

FIG. 4a shows an enlarged view of the third and fourth curtain head which are shown in FIG. 1;

FIG. 4b shows a schematic enlarged view in the direction of arrow A from FIG. 4a;

FIG. 5 shows a schematic enlarged perspective view of the curtain guide part of the guide face of the embodiment;

FIG. 6a shows a schematic view in the direction of arrow D in FIG. 1, which represents a modified example of a method for recovering color;

FIG. 6b shows a cross section along the line E-E from FIG. 6a;

FIG. 6c shows a cross section along the line F-F from FIG. 6a;

FIG. 7 shows a schematic perspective view of a first flow deflection device of the embodiment;

FIG. 8a shows a cross section along the line B-B in FIG. 7;

FIG. 8b shows a cross section along the line C-C in FIG. 7;

FIG. 9 shows a schematic perspective view of a second flow deflection device of the embodiment;

FIGS. 10a, 10b, 10c, and 10d show schematic views of the coating implemented on the basis of any one of the curtain heads 22, 23, 24; and

FIG. 11 shows a schematic cross section of the main part of the curtain applicator according to the prior art.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

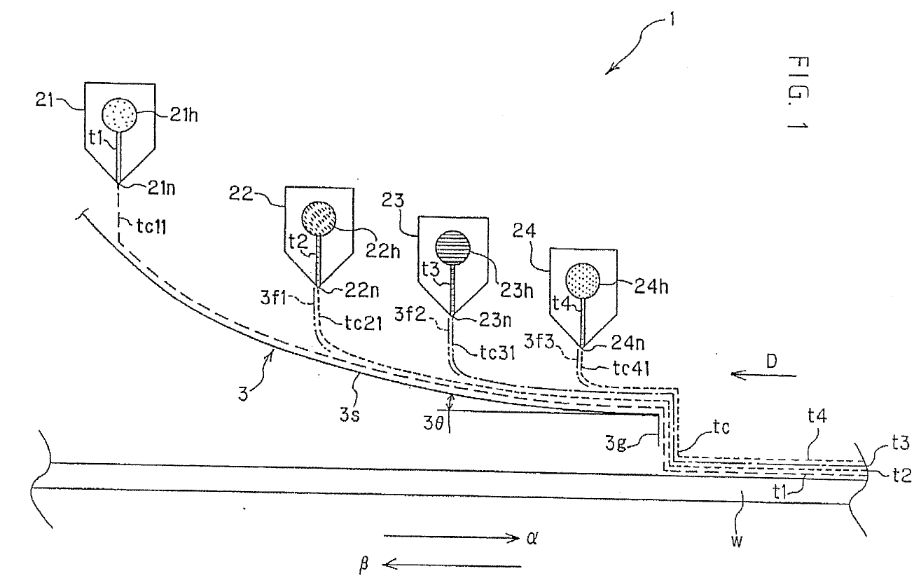

Referring now to the drawings, and more particularly to FIG. 1, there is shown a schematic cross section of an applicator 1 on which the current invention finds application. The device in FIG. 1 forms a device on which, during running in the direction of an arrow α (or an arrow β) of a web w to be coated, various colors t1, t2, t3, t4 are laminated on one side of the web w, as the result of which four applied layers are formed.

Although FIG. 1 presents an example in which four applied layers are used, it is also possible for two, three or five or more layers to be used.

The applicator 1 includes a first curtain head 21 for dispensing a first coating medium, e.g. a first color t1, and forming a medium or color curtain tc1, a second curtain head 22 for dispensing a second medium or a second color t2 and forming a medium or color curtain tc2, a third curtain head 23 for dispensing a third medium (hereinafter referred to only as “color” . . . for the sake of simplicity) or a third color t3 and forming a color curtain tc3, a fourth curtain head 24 for dispensing a fourth color t4 and forming a color curtain tc4, and a guide face 3 with a guide incline 3s onto which the color curtains tc1, tc2, tc3, tc4 are allowed to drop in order to form several color layers of the successively laminated colors t1, t2, t3 and t4.

It is possible to adjust each of the heights of each of the above described curtain heads 21, 22, 23, 24 from the guide face 3, the distance between these curtain heads and the angle of these curtain heads.

Although the curtain heads 21, 22, 23, 24 normally have the same width (in the vertical direction in FIG. 1), it is also possible to change these widths in advance.

To adjust the application width, provision is made for a device (not illustrated) for separating the coating liquids between the outlets of the curtain heads 21, 22, 23, 24 and the most distant downstream end of the guide face 3, by way of which the surplus of colors t1, t1, t3 and t3 is recovered and the colors t1, t2, t3, t4 are applied as required in layers on the web w.

The above described web is moved in the direction of arrow a at a speed of for example 1200m/min (20 m/sec), and the colors t1, t2, t3, t4 flowing in the laminated layers on the incline flow down from a curtain guide part 3g, which is continuous with the end part of the incline of the guide face 3, and form a color curtain tc with a speed of for example 3 to 5 m/sec which drops and is applied onto the surface of the web w.

The above described curtain heads 21, 22, 23, 24 include the collectors 21h, 22h, 23h, 24h, and the colors t1, t2, t3, t4 are fed to each of the collectors 21h, 22h, 23h, 24h with a prescribed pressure, which is generated either by respective pumps (not illustrated) or by another air pressure system. In addition, the colors t1, t2, t3, t4 are fed to the collectors 21h, 22h, 23h, 24h so that they flow through the nozzles 21n, 22n, 23n and 24n respectively in order to be dispensed with a film thickness of 50 to 300 μm and a speed of 1 to 5 m/sec.

The above described guide face 3 is made for example from a plate of stainless steel or a resin face with a surface roughness of a maximum Ra 0.4.

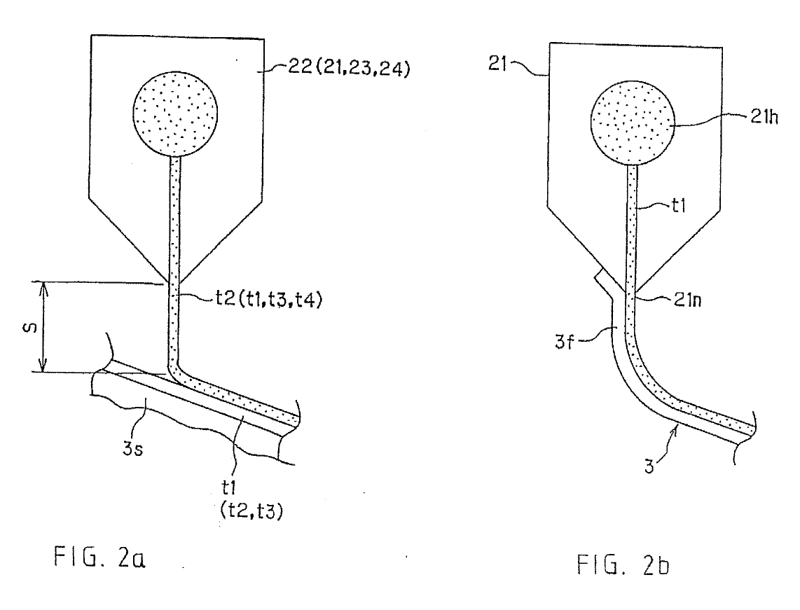

Although the guide face 3, as shown in the enlarged view in FIG. 2a, is arranged under each head, in the case of the first curtain head 21 according to the representation in FIG. 2b the first curtain head 21 and the guide face 3 are sometimes in direct contact. It should be noted that the range of a distance s between the curtain heads and the guide face 3 (see FIG. 2a), which is defined by the properties of the coating liquid, lies between 0.1 and 100 mm.

As shown in FIG. 1, the downward pointing curtain guide part 3g on the downstream end part incline 3s is constructed directly below the nozzle 24n of the fourth curtain head 24 in the direction of the web w.

It should be noted that the range of an angle of inclination 3q, whose cardinal point is the end of the incline 3s of the guide face 3, is set to between approx. 15 and 60° and on this device is set to 30°. It should be noted that the angle of inclination 3q of the incline 3s of the guide face 3 is randomly set.

Although the guide face 3 of this embodiment in the side view describes a curved line, it can also be constructed as a straight line.

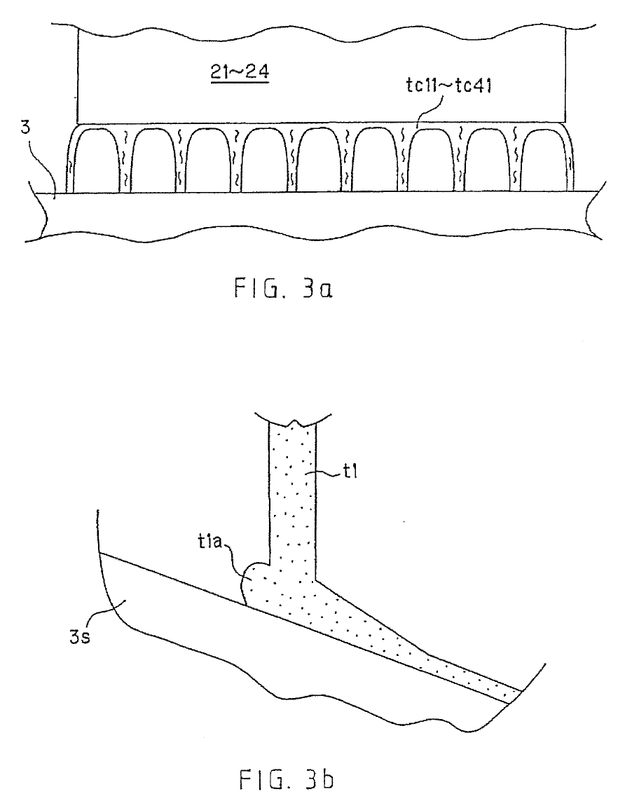

If the distance s between the curtain heads 21, 22, 23, 24 and the guide face 3, although dependent on the color properties, is not appropriate, as is evident in FIG. 3a with its schematic view in the width direction, then there will be a loss of continuity in the colors t1, t2, t3, t4 and a loss of continuity in the color curtains tc1, tc2, tc3 and tc4, which hinders the production of a uniform film thickness flow.

As is evident in FIG. 3b, which shows a schematic side view, the color t1 dispensed from the nozzle of the curtain head forms, upon touching the incline of the guide face 3, a color projection t1a which hinders the production of a uniform film thickness flow along the incline 3s.

To prevent this problem, as described above, the distance s between the curtain heads 21, 22, 23, 24 and the face 3, which corresponds to the color properties, is set in a range from 0.1 mm to 100 mm.

Or it is possible, as shown in FIG. 2b, to produce a uniform film thickness flow along the incline 3s of the guide face 3 in order, through the arrangement of a jet guide part 3f near the jet of the nozzle 21n for guiding the dispensed t1 uniformly onto the incline 3s of the guide face 3, to achieve a normal coating.

It should be noted that, as shown in FIG. 1, it is possible for the jet guide parts 3f1, 3f2 and 3f3 to be arranged in the second curtain head 22, third curtain head 23 and fourth curtain head 24 respectively, and in this case they are produced separately from the guide face 3.

Although the jet guide part 3f (see FIG. 2b) is shown on the current embodiment as an integral part of the guide face 3, it can also be provided separate from the guide face 3.

In this way it is possible to decide on providing a jet guide part according to the liquid properties of the colors and as appropriate for the dispensing conditions etc.

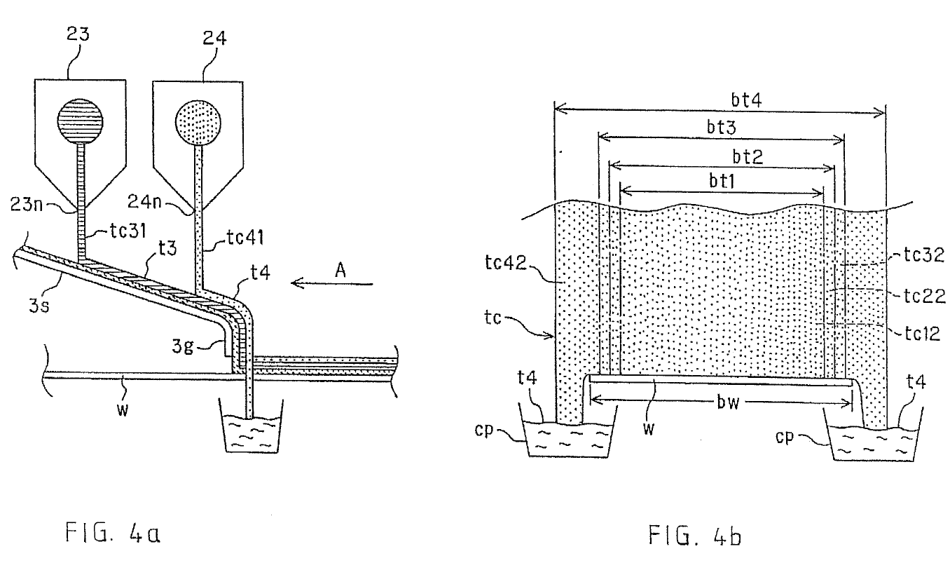

FIG. 4a is a schematic enlarged view of the third curtain head 23 and the fourth curtain head 24 in FIG. 1, and FIG. 4b is a schematic view thereof in the direction of the arrow A from FIG. 4a.

As shown in FIG. 4a, the color layers are formed by laminating the color t3 dispensed from the third curtain head 23 and the color t4 dispensed from the fourth curtain head 24 onto the other colors t1, t2 on the incline 3s of the guide face 3, and from the color layers t1, t2, t3, t4 a color curtain tc is formed and applied onto the surface of the web w by the curtain guide part, which is continuous with the end part of the incline 3s of the guide face 3.

Furthermore, as shown in FIG. 4b, of the color curtains tc which flow from the curtain guide part 3g, only the width bt4 of the color curtain tc42 of the color t4 is wider than the width bw of the web w, and the surplus color t4, which is not used for the coating, is caught and recovered by a color pan.

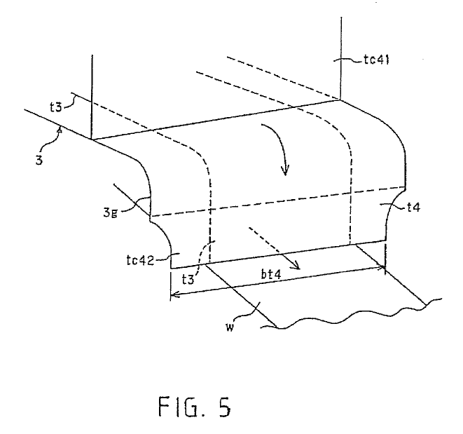

FIG. 5 shows a schematic enlarged perspective view representing the curtain guide part 3g used in the application step.

As shown in FIG. 5, owing to the fact that the two side end parts of only the top-most color t4 of the color curtain tc, which drops from the curtain guide part 3g of the guide face 3, are formed as a single thin layer, there arises a contraction due to surface tension, whereby the two side end parts of the color t4 are drawn to the center part and the surface of the web w is coated with a contracted color t4.

In view of the curtain width bt4 of the contracted color t4, the width of the color curtain tc41 dispensed from the fourth curtain head 24 (see FIG. 1) must be large.

As shown in FIG. 4b and in FIG. 5, owing to the fact that the two side end parts of the color t3 dispensed from the third curtain head 23 combine with the color t4 and form two coatings when they flow down the curtain guide part 3g, the force of this falling flow is greater than the surface tension and, unlike what happens with color t4, there is no contraction as the result.

As the two side end parts of the colors t2 and t1, which flow down the curtain guide part 3g, combine to form three layers and four layers, the force of their downward flowing flow is likewise great, and there is no contraction as the result of surface tension.

As shown in FIG. 4b, the color t3 dispensed from the third curtain head 23 is dispensed with the width of the nozzle 23n, which is set to a width bt3 which is narrower than the width bt4 of the color curtain tc42 of the color t4 and than the width bw of the web w.

In addition, the color t2 is dispensed from the second curtain head 22 with the width of the nozzle 22n which is set to the width bt2 which is narrower than the width bt3 of the color curtain tc32 of the color t3, and the color t1 is dispensed from the first curtain head 21 with a width bt1 which is narrower than the width bt2 of the color curtain tc22 of the color t2.

It should be noted that the width bt2 of the color t2 is set on each side 10 mm narrower than the width bt3 of the color t3, and the width bt1 of the color t1 is set on each side 10 mm narrower than the width bt2 of the color t2.

In this way the color layers of the color layers dispensed from the curtain heads of the downstream side and flowing along the incline 3s of the guide face 3 are wider than the color layers dispensed from the adjacent curtain heads of the upstream side and cover the two side edges of the color layers.

As the result, the side end parts of the color layers do not lap and, furthermore, are controlled by adjacent colors of the upper layer dispensed from curtain heads of the downstream side. Hence the color layers are stable and a normal coating of the web w can be achieved accordingly.

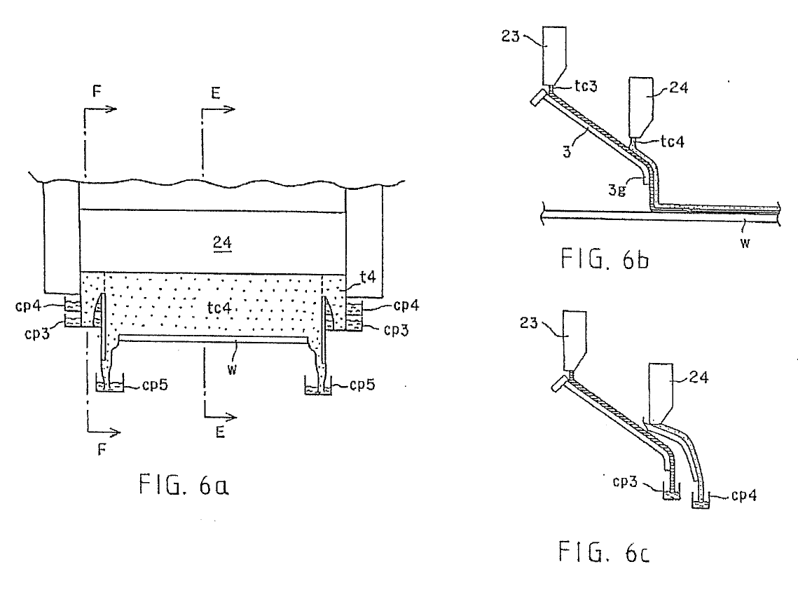

There now follows a description with reference to FIG. 6a, which is a schematic perspective view in the direction of arrow D in FIG. 1 of a modified example of the method for recovering the surplus of color used during the application.

This example shows the dispensing of the colors t3 and t4, which use only a third curtain head 23 and a fourth curtain head 24.

In the application region, the color t3 dispensed from the third curtain head 23 forms, as shown in FIG. 6b, which is a cross section along the line E-E in FIG. 6a, a color curtain tc3 which flows downward along the guide face 3, and the color t4 dispensed from the fourth curtain head 24 forms a color curtain tc4 which flows downward along the guide face 3, whereby a layer laminate is formed and flows along the incline 3s of the guide face 3. In addition, the layered colors t3, t4 flow down from a curtain guide part 3g, which is continuous with the end part of the incline 3s of the guide face 3, and drop onto the surface of the web w and coat it.

As shown in FIG. 6c of the cross section along the line F-F in FIG. 6a, the surplus color t4 of the color dispensed from the fourth curtain head 24 is caught by color pans cp4, cp4, and the surplus color t3 of the color t3 dispensed from the third curtain head 23 is caught by color pans cp3, cp3.

It should be noted that, as shown in FIG. 6a, a small quantity of surplus color containing a mixture of the colors t4 and t3 is caught by the color pans cp5, cp5.

Although the above described modified example represents a case in which no curtain heads 21, 22 are used, if the curtain heads 21, 22 are used, then surplus color containing a mixture of the colors t1 and t2 will be recovered by the color pans cp3, cp3.

If the curtain heads 21, 22 are not used, as shown in this case, then the surplus color t3 from the third curtain head 23 can be recovered independently only by the color pans cp3, cp3.

On the other hand, the surplus color t4 from the fourth curtain head 24 can be caught independently without mixing by the color pans cp4, cp4.

If the coating is performed using only the fourth curtain head 24 and the third curtain head 23, then the surplus colors t4 and t3 respectively can be caught independently.

There now follows a description of a first flow deflection device B1, which is used for setting the width bt1 of the color t1 dispensed from the first curtain head 21.

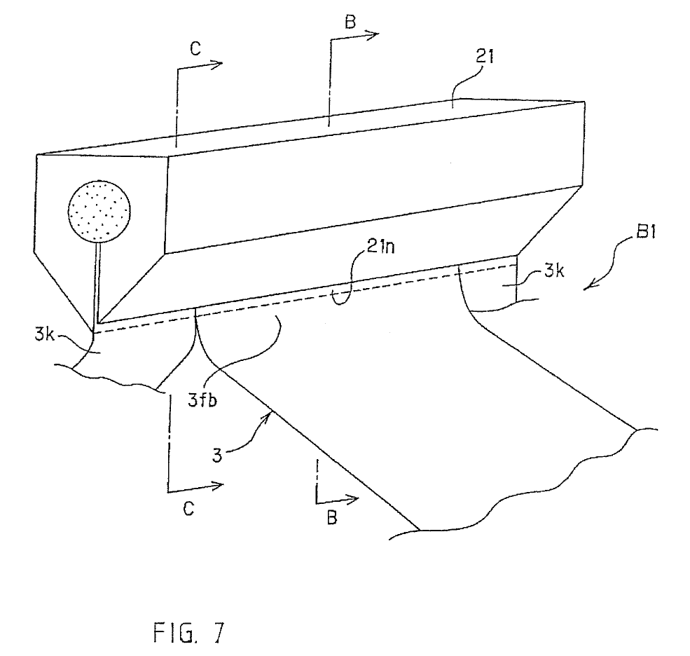

On the first flow deflection device B1, as shown in FIG. 7, the jet guide part 3f, which is arranged near a nozzle 21n of the first curtain head 21, is constructed in the form of a block on which a center color guide part 3fb with the width of the color t1 is used to guide the color t1h for application, and side recovery parts 3k, 3k are provided separate and in various directions for guiding the color t1 which is to be recovered.

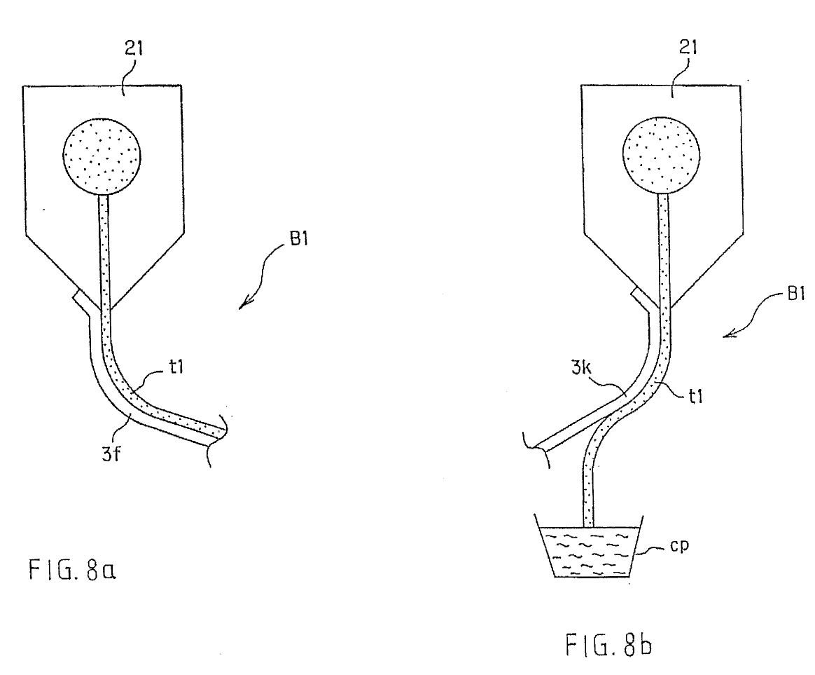

Through the dispensing of the color t1 from the nozzle 21 to the color guide part 3fb and to the recovery guide parts 3k, 3k, the color t1 used for the application is guided, as shown in FIG. 8a, which is a cross section along the line B-B in FIG. 7, during its flow along the color guide part 3fb with the prescribed application width of the coating, meaning with the width of the color guide part 3fb, and the surplus color t1, which is not used for the coating, is guided, as shown in FIG. 8c, which is a cross section along the line C-C in FIG. 7, during its flow along the recovery guide parts 3k, 3k in order to be caught and recovered by the color pans cp.

Through such a setting of the width of the color guide part 3fb near the nozzle 21n, the setting and positioning of the width of the color t1 to be applied can be reliably and easily carried out, the surplus color t1 can be recovered and the color t1 can be effectively used.

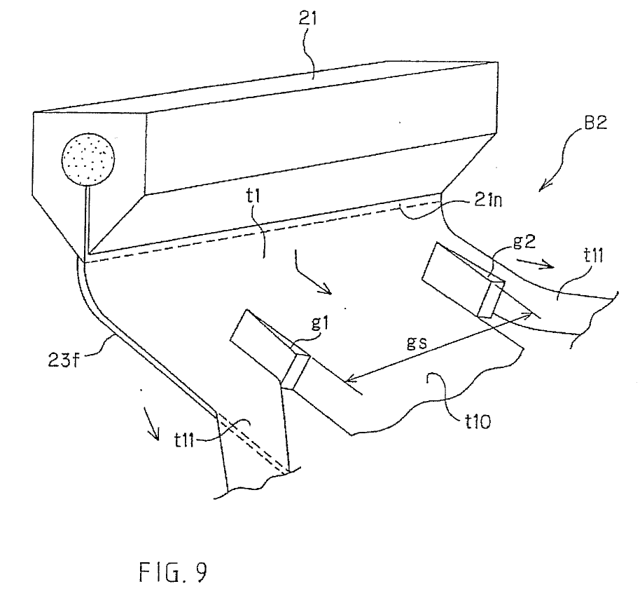

FIG. 9 shows a second flow deflection device B2 as a modified example of the first flow deflection device B1.

On this configuration provision is made in a jet guide part 23f, which is arranged near the nozzle 21n of the first curtain head 21, for a pair of flow deflection guide members g1, g2 with a wedge shape which gradually grows larger in the direction of the downstream side. The width dimension gs between the flow deflection guide members g1, g2 is set to the width measurement of the color t1 used for the coating.

When the second flow deflection device B2 is used and the color t1 is dispensed from the nozzle 21n, the color t1 flows along the jet guide part 23f and, through the action of the flow deflection guide members g1, g2, between said members such that it becomes a flow-deflected color t10 which is to be used for coating the same width as the width measurement gs between the flow deflection guide members g1, g2 and the surplus colors t11, t11, which flow along the outer side of the flow deflection guide members g1, g2.

After an equilibrium has been established between the respective surface stresses of the color t10 to be applied and the surplus colors t11, t11, which are separated by the flow deflection guide members g1, g2, it is possible on the basis of this configuration to prevent a repetition of this flow deflection. It should be noted that an effective flow deflection was assured when the width of each of the right-angled flow deflection guide members g1, g2 in the flow direction of the color t1 was set to a dimension of the magnitude of at least 10 mm.

On the basis of this configuration it is possible, through the recovery of the surplus colors t11, t11, to achieve a color saving, and the color t1 can be effectively used.

There now follows a description of the application process with which, by using the applicator 1 of the above described configuration, it is possible to form several color layers of various colors t1, t2, t3, t4 on one side of a web w.

As shown in the FIGS. 1 and 2a, first the color t1 is dispensed from a first curtain head 21 and applied as a first layer onto a jet guide part 3f.

At this moment the first flow deflection device B1 shown in FIG. 7 or the flow deflection device B2 shown in FIG. 9 sets the width of the color t1 used for the coating to a prescribed width and the surplus color t1 is flow-deflected so that it can be caught and recovered by color pans cp.

The color t2 applied as the second layer is dispensed, as shown in the FIGS. 1 and 2b, from the nozzle 22n of the second curtain head 22 in a width bt2 which is greater than the width bt1 of the first layer of the color t1 (see FIG. 4b), for example 10 mm wider on each side than the width bt1 of the color t1, and is applied, as shown in the FIGS. 1 and 3b, onto the first layer of the color t1, which flows along the incline 3s of the guide face 3.

The color t3 applied as the third layer is dispensed, as shown in the FIGS. 1, 2b and 4b, from the nozzle 23n of the third curtain head 23 in a width bt3 which is greater than the width bt2 of the second layer of the color t2 (see FIG. 4b), for example 10 mm wider on each side than the width bt2 of the color t2, and is applied onto the second layer of the color t2 which flows along the incline 3s of the guide face 3.

The color t4 applied as the fourth layer is dispensed, as shown in the FIGS. 1, 2b and 5, from the nozzle 24n of the fourth curtain head 24 in a width which is greater than the width bt3 of the third layer of the color t3, and, under formation of a width bt4 after contraction, is applied, as shown in FIG. 4b, onto the third layer of the color t3 which flows along the incline 3s of the guide face 3.

It should be noted that the positional relationship between the pointed end part of the curtain head 22 and the first layer of the color t1, which flows along the guide face, is set such that optimum conditions according to the liquid state of the colors t1, t2 are created by moving the second curtain head 22 and the guide face 3 etc.

Similar to the procedure for the above described curtain head 22, it is also possible for the third curtain head 23 and the fourth curtain head 24 to be set in order to create optimum conditions by moving the curtain head and the guide face 3.

As shown in FIG. 1 and in FIG. 4, the colors t1, t2, t3, t4, which form four layers on the guide face 3, thus flow along the incline 3s of the guide face 3, whereupon, during guidance along the curtain guide part 3g where they separate from the guide face 3, a color curtain tc is formed as the result of gravity and is applied onto the surface of the web w, and a coating including 4 layers of the colors t1, t2, t3, t4 is obtained on the surface of the web w.

Multilayer application on a surface of a web w can be achieved in the same way by using a random number of colors.

It should be noted that, although in the example of the current embodiment a jet guide part 3f is provided only for the first layer of the color t1, jet guide parts can be arranged randomly in any of the curtain heads as required according to the liquid state of colors with a low flow rate etc.

If either the first flow deflection device B1 shown in FIG. 7 or the flow deflection device B2 shown in FIG. 9 is arranged to provide the flow deflection of the color to be applied and to recover the color, then only the required color is used for the application and the surplus color can be recovered.

In this way a web w, on which several layers of the colors t1, t2, t3, t4 are applied, is used, after a drying step, to form a paper product on which areas where a normal coating has not taken place, as indicated for example by spot formation, are removed by cutting off.

It should be noted that on the coating implemented in the above described examples, as shown in FIG. 1, on account of the fact that the web w runs in the direction of the arrow a the coating of the surface of the web w takes place with a color layer of a color t1, which forms a first layer, a color layer of a color t2, which forms a second layer, a color layer of a color t3, which forms a third layer, and a color layer of a color t4, which forms a fourth layer. But if the web w runs in the direction of the arrow b of the surface of the web w, then a coating is possible on which the color layer of the color t4 forms the first layer, the color layer of the color t3 forms the second layer, the color layer of the color t2 forms the third layer and the color layer of the color t1 forms a fourth layer.

On the basis of the above described configuration it is possible in addition, depending on the type of product to be coated, to feed and stop the color to random curtain heads, whereupon the color for a stopped curtain head which drops into a color pan can be circulated by using a pipe or a pump or the like (not illustrated in the drawing) which serves as a way of circulation.

In addition, the curtain heads 21, 22, 23, 24 can be switched over during the implementation of the coating, whereupon the color for the curtain heads not used during the application is collected by color pans and circulated in the standby state by a circulation device, and in addition water instead of color can be made to flow to said curtain heads from a special water pump or a special water pipe which forms a feeding device (not illustrated in the drawing).

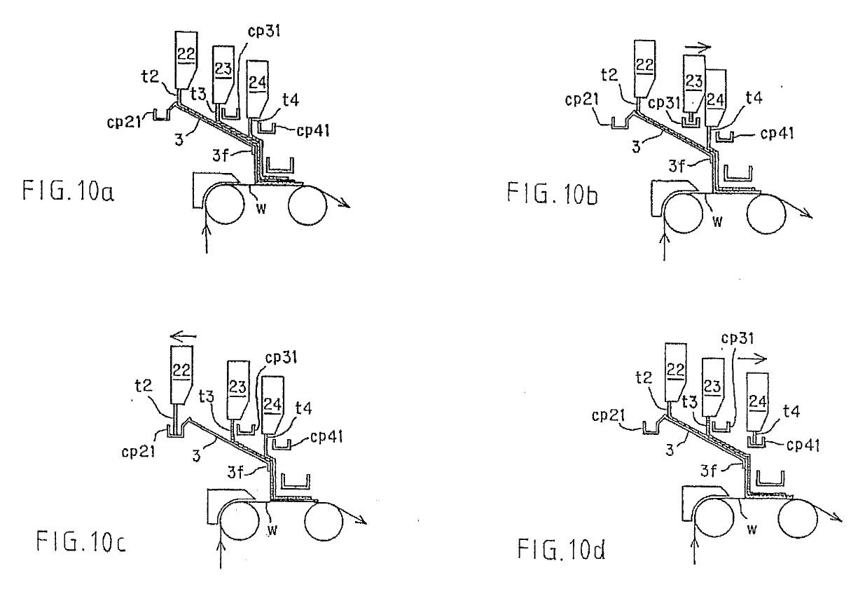

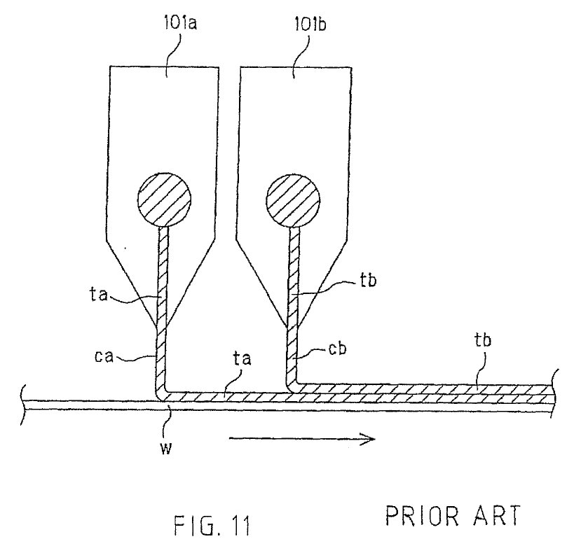

The representations in FIG. 10 show by way of example a schematic view of a coating implemented on the basis of a random selection of the colors t2, t3, t4 used by the curtain heads 22, 23, 24.

FIG. 10a shows a lamination of the surface of the web w, which is coated in succession by the color t2 from the second curtain head 22, the color t3 from the third curtain head 23 and the color t4 from the fourth curtain head 24. Here the colors t2, t3, t4 are not caught and recirculated by the color pans (collecting containers) cp21, cp31, cp41.

FIG. 10b shows a lamination of the surface of the web w, which is coated in succession by the color t2 from the second curtain head 22 and the color t4 from the fourth curtain head 24. In this case the third curtain head 23 has already been moved into the standby position and the color t3 from the third curtain head 23 is caught and circulated by the color pan cp31, whereupon water instead of the color t3 is circulated in order to clean said curtain head.

FIG. 10c shows a case in which a surface of the web w is lamination-coated in succession by the color t3 from the third curtain head 23 and the color t4 from the fourth curtain head 24. In this case the second curtain head 22 has already been moved into the standby position and the color t2 from the second curtain head 22 is caught and circulated by the color pan cp21, whereupon water instead of the color t2 is circulated in order to clean said curtain head.

FIG. 10d shows the case in which a surface of the web w is lamination-coated in succession by the color t2 from the second curtain head 22 and the color t3 from the third curtain head 23. In this case the fourth curtain head 24 has already been moved into the standby position and the color t4 from the fourth curtain head 24 is caught and circulated by the color pan cp41, and water instead of the color t4 is circulated in order to clean said curtain head.

On the basis of the above described configuration, the first layer of the color t1 is stable as it is guided during its flow along the incline 3s by the jet guide part 3f without formation of a curtain.

On account of the fact that a color layer, which was formed in several layers by the falling of other color curtains over a second layer on a first layer of liquid color, drops onto the surface of the web w, the total film thickness of the color curtain falling down onto the web surface 2 is formed thicker, and it is possible to achieve a stabilization of the color curtain tc used directly in the coating of the surface of the web w with a lower flow rate than any of the colors.

Accordingly, an application with a low flow rate is possible, and a color saving can be achieved.

For this reason it is possible, on the web w running at high speed, to implement a stable coating, to perform a uniform coating without spot formation or irregularity or the like, and to create a coating of high quality.

On account of the fact that stable color layers can be maintained even at high flow rates, which was difficult when using the multilayer applicators of the prior art, it is possible in addition to produce thick coatings with a thick film thickness.

On account of the fact that a multilayer color curtain is formed by gravity upon separation of the color layers from the guide face 3, it is possible in addition in the same way as for the curtain application of the prior art to randomly set the distance to the article to be coated, and the optimum distance corresponding to the application speed can be set.

The application width of the color layers can be set in addition prior to their formation in several layers on the incline 3s of the guide face 3, and this width setting of the color layers to be applied to the web w is easy. Consequently, the application process is easy.

Furthermore, there is no mixing of the surplus of colors, and they can be recovered singly.

As the color layer flowing along the guide face 3 flows with a width which covers the adjacent two side edges of the lower color layer, the flow of the color layers is stable in addition, whereupon the color curtain tc directly prior to the application is also stable.

If a jet guide part is arranged near the jet nozzle of the curtain heads, it is possible in addition to produce a stable color layer flowing along the incline 3s of the guide face 3, and a normal coating on the surface of the web w is possible even at low color flow rates.

If a first flow deflection device B1 and a second flow deflection device B2 for setting the color width are arranged in the jet guide part arranged near the jet nozzle, then it is possible in addition for the flow deflection process of the color to be recovered and the surplus color to be implemented without problem.

For this reason the application step can be implemented using the best suited and optimum quantity of color, the surplus color can be recovered and used again, and an effective utilization of the color can be achieved.

Owing to the fact that, after the stabilization of the application layers, it is possible to form several layers of the color layers, an improvement in the quality of the product coated with color layers is achieved in addition.

Depending on the type of product to be coated, it is possible in addition for the color to be fed and stopped to random curtain heads, and the curtain heads 21, 22, 23 and 24 can be switched over during the implementation of the coating, whereupon the color of the curtain heads not used during the application can be collected in color pans and be circulated in the standby state, and water for cleaning said curtain heads can be circulated in addition.

Even when the type of product to be coated is changed, it is possible accordingly to circulate water or the like to the curtain heads not used for the coating in order to clean them.

It should be noted that, although an example of this embodiment was described on which the color layer on the downstream side is wider than the color layer on the upstream side, the width of the downstream side could also be smaller than the width of the color layer on the upstream side, or the widths of all color layers can be the same.

With these configurations it is possible to achieve the same effect as described above.

Accordingly it is possible to provide an applicator for the curtain application method for performing a multilayer application using several coating media or colors with improved freedom for selecting the individual layers.

Practical examples of the use to which the invention can be put are on applicators for applying color to calenders, catalogs, pressure-sensitive paper, heat-sensitive paper and photographic film for example, as well as on applicators or the like for applying medium onto a magnetic material on one side of cards for automatic platform barriers.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### LIST OF REFERENCE NUMERALS

1 Applicator
21 First curtain head (top-most curtain head on the flow side)
22 Second curtain head
23 Third curtain head
24 Fourth curtain head
3 Guide face
3f, 3f1, 3f2, 3f3 Jet guide parts
3fb Coating medium or color guide part
3g Curtain guide part
3k Recovery guide part
3s Incline
cp21, cp31, cp41 Circulation color pans (collecting containers)
g1, g2 Flow deflection guide members
t1, t2, t3, t4 Coating media or colors
tc Medium curtain or color curtain
w Web

What is claimed is:

1. An applicator for applying a coating of a coating medium in a plurality of layers onto a running web surface of a web, said applicator comprising:
a plurality of curtain heads arranged at random distances apart from each other, each said curtain head being configured for dispensing downward the coating medium; and
an inclined guide face including a guide incline and a curtain guide part, said plurality of curtain heads arranged along said guide incline, said inclined guide face configured for moving the plurality of layers at an end part of said guide incline onto the web surface as a result of a lamination of the curtain medium dispensed one after the other from each of said plurality of curtain heads along said guide incline to form the plurality of layers and to form a color curtain from said curtain guide part pointing downwards.

2. The applicator according to claim 1, wherein each layer of said plurality of layers moved along said guide incline and dispensed from a curtain head of said plurality of curtain heads lying on a downstream side of the applicator, relative to a running direction of the web, is wider than and covers two side edges of a layer of said plurality of layers dispensed from an adjacent curtain head of said plurality of curtain heads lying on an upstream side of the applicator.

3. The applicator according to claim 1, wherein at least one of said plurality of curtain heads includes a jet guide part configured for being arranged near a medium jet and for guiding a dispensed coating medium onto said inclined guide face.

4. The applicator according to claim 3, wherein said plurality of curtain heads includes a top-most upstream curtain head, said jet guide part being arranged in said top-most upstream curtain head.

5. The applicator according to claim 3, wherein said jet guide part includes a medium guide part and a recovery guide part, said medium guide part configured for guiding to said guide incline the coating medium dispensed from said at least one of said plurality of curtain heads, said recovery guide part arranged alongside and in a different direction to said medium guide part and configured for deflecting a flow of a surplus of the coating medium.

6. The applicator according to claim 3, wherein said jet guide part includes a pair of wedge-shaped flow deflection guide members which grow larger toward a downstream side of the applicator, a distance between said pair of wedge-shaped flow deflection guide members having a same dimension as a width of the coating medium used in the coating, the coating medium flowing between said pair of wedge-shaped flow deflection guide members being usable for coating the web surface, the coating medium flowing along an outer side of said pair of wedge-shaped flow deflection guide members being recoverable.

7. The applicator according to claim 1, further including a container and a circulation device, said container for catching the coating medium dispensed from at least one of said plurality of curtain heads which is not used for the coating, said circulation device for recirculating to said plurality of curtain heads the coating medium caught by said container.

8. The applicator according to claim 1, further including a feeding device for feeding water to individual ones of said plurality of curtain heads which are not used for the coating, a container for catching said water dispensed from said plurality of curtain heads, and a circulation device for recirculating to said plurality of curtain heads said water caught by said container.

9. The applicator according to claim 1, wherein the coating medium dispensed from said plurality of curtain heads forms a plurality of curtains, a width of at least one of said plurality of curtains dispensed from one of said plurality of curtain heads being wider than a width of the web to be coated.

10. The applicator according to claim 1, wherein the coating medium dispensed from said plurality of curtain heads forms a plurality of curtains, a width of at least one of said plurality of curtains dispensed from one of said plurality of curtain heads being narrower than a width of the web to be coated.

11. The applicator according to claim 1, wherein the coating medium dispensed from said plurality of curtain heads forms a plurality of curtains, a respective one of said plurality of curtains resulting from one of said plurality of curtain heads lying on a downstream side of the applicator being wider than a width of the web to be coated, and a respective one of said plurality of curtains resulting from an adjacent one of said plurality of curtain heads lying on an upstream side of the applicator being narrower than a width of the web.

12. The applicator according to claim 1, wherein the coating medium includes a coating color.
